(19) United States
(12) Patent Application Publication
(10) Pub. No.: US 2004/0123139 A1
(43) Pub. Date: Jun. 24, 2004

(54) System having filtering/monitoring of secure connections

(75) Inventors: William A. Aiello, Madison, NJ (US); Steven Michael Bellovin, Westfield, NJ (US); Evan Stephen Crandall, Basking Ridge, NJ (US); Alan Edward Kaplan, Morris Township, NJ (US); David P. Kormann, Morristown, NJ (US); Aviel D. Rubin, West Caldwell, NJ (US); Norman Loren Schryer, New Providence, NJ (US)

Correspondence Address: AT&T CORP., P.O. BOX 4110, MIDDLETOWN, NJ, 07748, US

(73) Assignee: AT&T Corp., New York, NY

(21) Appl. No.: 10/322,189

(22) Filed: Dec. 18, 2002

(51) Int. Cl. H04L 9/00

(52) U.S. Cl. 713/201

(57) ABSTRACT

Traffic over a secure link or tunnel is filtered to block packets that do not conform to specified requirements for the tunnel. In one embodiment, a private network, such as an ISP network, includes a filter for blocking packets not associated with an IPSec VPN tunnel. The ISP network and/or one or both of the tunnel endpoints can include monitoring modules for detecting the presence of packets that should have been blocked by the filter.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The present invention relates generally to communication systems and, more particularly, to communication systems providing secure communication links.

### BACKGROUND OF THE INVENTION

As is known in the art, there are a variety of protocols for providing secure communication over networks, such as the Internet. One such protocol is the IPSec protocol, which is becoming a widely accepted way to secure communications over the Internet. The IPSec protocol is designed to be flexible in accommodating various operational scenarios. For example, the IPSec protocol provides secure remote access to corporate intranets for those corporate employees who need to access resources in protected portions of a corporate intranet while working remotely. The IPSec protocol tunneling mode is often used for such a scenario where an IPSec tunnel is formed between a remote host and a VPN (Virtual Private Network) gateway so that IP (Internet Protocol) packets can be securely transferred between the remote host and the corporate intranet to which the VPN gateway is connected.

Even in the presence of security protocols, such as the IPSec protocol, the risks of configuring a network having a computer simultaneously connected inside and outside a firewall are well known. For example, attackers have gained access to such a computer and then launched an attack on systems inside the firewall. The level of network security further decreases with mobile telecommuter devices connected via a VPN to a corporate intranet. For example, such devices can malfunction so as to compromise network security.

It would, therefore, be desirable to overcome the aforesaid and other disadvantages.

### SUMMARY OF THE INVENTION

The present invention provides a system having enhanced security features for verifying the proper operation of clients, devices, and/or filters over a secure connection. The data exchange over a secure channel or link, such as a Virtual Private Network (VPN) tunnel, can be monitored to detect potential security breaches. With this arrangement, filters for filtering non-VPN packets that allow a non-VPN packet to pass can be identified. The parties to the tunnel can be alerted to the security breach. While the invention is primarily shown and described in conjunction with remote devices over a VPN using the IPSec protocol, it is understood that the invention is applicable to communication systems in general in which it is desirable to provide secure communication channels.

In one aspect of the invention, a first network, such as an Internet Service Provider (ISP) network, includes a filter module for filtering packets over a tunnel between tunnel endpoints. In one particular embodiment, the tunnel is provided as an IPSec VPN tunnel between a corporate intranet and a mobile host via the Internet. The filter module filters packets passing through the tunnel that are not packets associated with the tunnel.

In another aspect of the invention, the first network further includes a monitor module for detecting packets in the tunnel that do not meet specified requirements. In one embodiment, the monitor module detects non-VPN, e.g., unencrypted packets. The monitor module can then send an alert message to one or both of the parties to the tunnel.

In alternative embodiments, monitor and/or filter modules are co-located at one or more of the tunnel hosts, e.g., corporate intranet, mobile host, private network, gateway, and the like.

### BRIEF DESCRIPTION OF THE DRAWINGS

The invention will be more fully understood from the following detailed description taken in conjunction with the accompanying drawings, in which:

FIG. 1 is a block diagram of a network having secure channel filtering/monitoring in accordance with the present invention;

FIG. 2 is a pictorial representation of an exemplary IPSec tunnel mode packet that can form a part of the system of FIG. 1;

FIG. 3 is a pictorial representation of an exemplary IPSec-based roadmap that can form a part of the system of FIG. 1;

FIG. 4 is a pictorial representation of an exemplary ESP header that can form a part of the system of FIG. 1;

FIG. 5 is a pictorial representation of an exemplary tunnel mode ESP packet that can form a part of the system of FIG. 1;

FIG. 6 is a pictorial representation of an exemplary TCP/IP protocol stack;

FIG. 7 is a block diagram of a mobile station coupled to an ISP network via a secure tunnel with filtering/monitoring in accordance with the present invention; and

FIG. 8 is a block diagram of an intranet that can be coupled to the mobile station of FIG. 7 via a secure tunnel in accordance with the present invention.

### DETAILED DESCRIPTION OF THE INVENTION

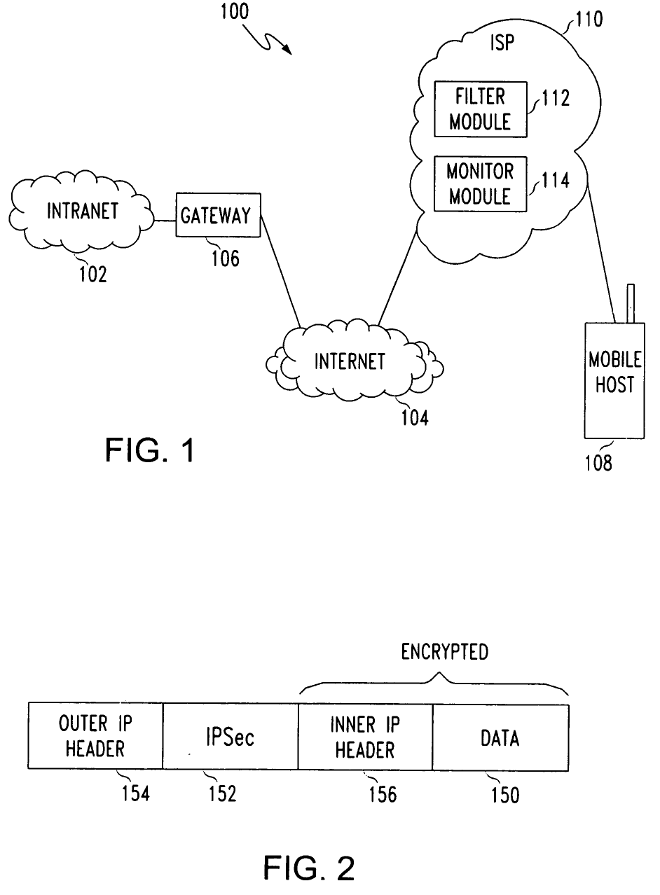

FIG. 1 shows an exemplary network 100 having secure channel monitoring in accordance with the present invention. In general, packets are filtered and/or monitored to detect the presence of packets that do not meet security protocol requirements for a secure channel, such as an IPSec VPN tunnel between a mobile device and a corporate intranet. Upon detection of the presence of non-VPN packets, the parties to the tunnel can be alerted to the security breach.

In an exemplary embodiment, the network 100 includes a first network 102, such as a corporate intranet, coupled to the Internet 104 via a gateway 106. A remote client 108, e.g., a mobile host, which is served by an Internet Service Provider (ISP) network 110, can communicate with the corporate intranet 102 via the ISP network and the Internet 104. In an exemplary embodiment, the mobile host 108 can initiate a Virtual Private Network (VPN) connection with the intranet 102 using the IPSec protocol (RFC 2401). A filter module 112 within the ISP network 110 can filter non-VPN packets in the tunnel so that only VPN packets should reach the connected parties, e.g., the mobile host 108 and the gateway 106. The ISP network 110 can also include a monitor module 114 for monitoring data exchange through the tunnel to detect non-VPN packets, as described in detail below.

Before further describing the invention, the IPSec (RFC 2401) protocol is now described in conjunction with WPv4 (Internet Protocol version 4), which provides a 32-bit addressing scheme in a connectionless service. As is well known in the art, the IPSec protocol includes a suite of protocols including Authentication Header (AH-RFC 2402), Encapsulation Security Payload (ESP-RFC 2406), Internet Key Exchange (IKE), and Internet Security Association and Key Management Protocol (ISAKMP)/Oakley, and transforms, all of which are incorporated herein by reference. The ESP and AH protocol each include transport and tunnel modes.

As shown in FIG. 2, in tunnel mode an IP packet 150 to be protected is encapsulated in another IP datagram and an IPSec header 152 is inserted between an outer IP header 154 and an inner IP header 156. The communication endpoints (e.g, the gateway 102 and mobile host 108 of FIG. 1) are specified in the inner (protected) header and the cryptographic endpoints are set forth in the outer IP header. The inner IP header 156 and payload 150 are encrypted. The security gateway decapsulates the inner IP packet upon conclusion of IPSec processing and forwards the packet to its ultimate destination within the corporate intranet.

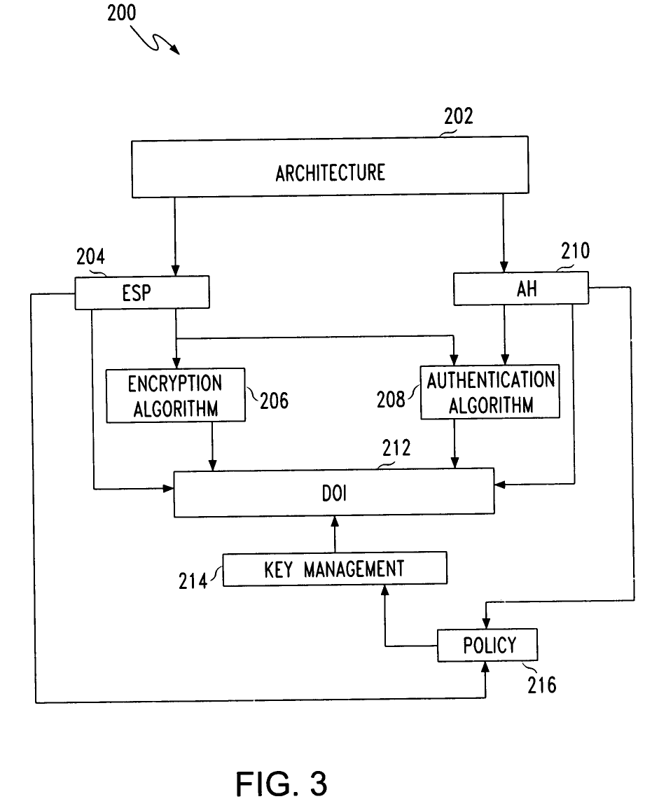

FIG. 3 shows an exemplary IPSec roadmap 200. An architecture 202 defines the capabilities required of hosts and gateways. The ESP module 204 communicates with an encryption algorithm 206 and an authentication algorithm 208, which communicates with the AH module 210. The encryption and authentication algorithms 206, 208 interact with the domains of interpretation (DOI) 212, which also interfaces with the ESP 204 and AH 210 modules. The DOI 212 defines the IKE parameters that are negotiated for the protocols. A key management module 214 interacts with the DOI 212 as well as the policy module 216, which communicates with the ESP 204 and AH 210 modules.

The ESP module 204 provides confidentiality with the encryption algorithm 206 and data integrity with the authentication algorithm 208. The particular algorithms used for the encryption algorithm 206 and the authentication algorithm 208 are determined by the corresponding components of the ESP security association (SA).

As is known in the art, IPSec can be implemented in a variety of ways including a host implementation, an operating system integration arrangement, a bump in the stack (BITS) implementation (IPSec inserted between the network and link layer), a bump in the wire encryptor (hardware device cabled between a computer and its network jack), and router implementations. The IPSec roadmap and implementation configurations are well known to one of ordinary skill in the art.

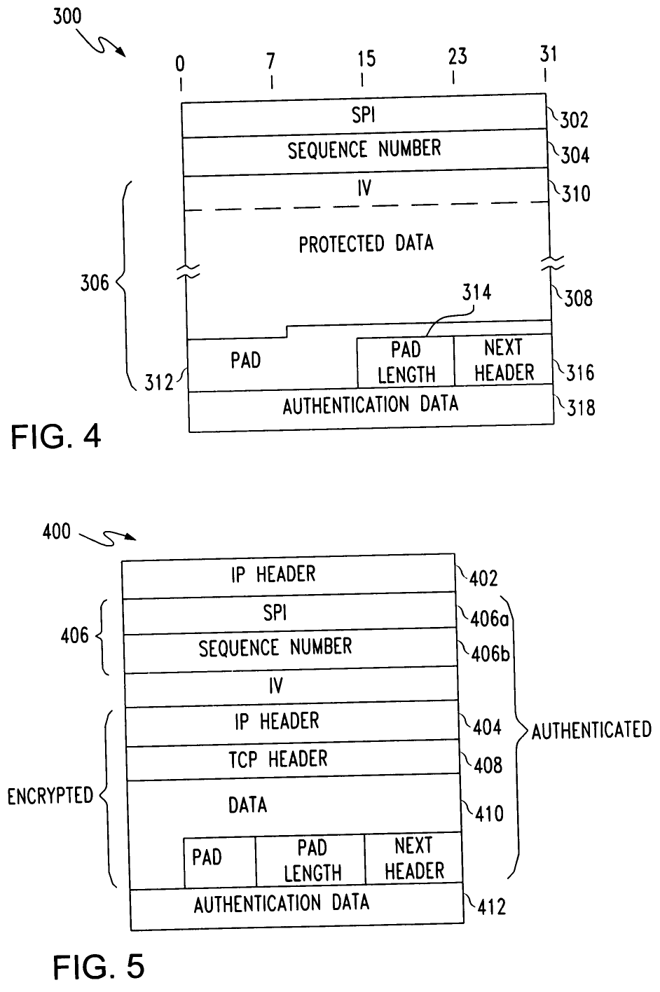

ESP provides confidentiality, data integrity, and data source authentication of IP packets. An exemplary ESP header 300 along with a data payload 306 is shown in FIG. 4. It is understood that the preceding IP header 154 (FIG. 2) identifies the subsequent header as an ESP header (or AH header). The header that follows the ESP header upper layer, e.g., TCP (Transmission Control Protocol) header or another IP header, is determined by the ESP header based upon the security association (SA).

The SPI field 302 contains an arbitrary number selected by the destination, typically during the IKE exchange. It is understood that the SPI is authenticated but not encrypted. The sequence number 304 provides so-called anti-replay functionality. The protected data field 306, which contains the data being protected by IPSec 308, can also contain an initialization vector (IV) 310 that may be required for an encryption algorithm. The payload 306 can also include a data pad 312, a pad length 314 and the next header 316 fields. An optional authentication field or trailer 318 holds the result of the data integrity check, which can correspond to a keyed hash function.

FIG. 5 shows an exemplary tunnel mode ESP packet 400 including an outer IP header 402 and an inner IP header 404 surrounding the ESP header 406. The inner IP header 404 is followed by a TCP header 408. The payload 410 and the authentication data 412 follow the TCP header 408. As shown, the SPI field 406a contiguously through the data field 410 are authenticated and the inner IP header 404 through the data field 410 are encrypted.

For outbound ESP tunneling mode processing, the ESP header 406 is prepended to the IP packet 410 and the header fields described above are filled in. The ESP header 406 includes a field that corresponds to the IP version, e.g., IPv4 or IPv6. The outer IP header 402 is then prepended to the ESP header 406 and the IP header fields are filled in. The source address is the device that is applying ESP, the destination address is taken from the SA used for ESP, and the protocol value is set to a predetermined value, e.g., 50.

Then applicable portions of the packet, e.g., inner IP header 404, TCP header 408 and data 410, are the encrypted using the cipher from the SA. The packet is then authenticated using the authenticator in the SA. It is understood that the authenticator output is placed in the authentication data field 412 of the packet.

For input ESP packet processing, it is understood that the receiver initially does not know whether the packet is a transport or tunnel mode ESP packet. Based upon the SA (if any) used to process the packet, the receiver knows what it should be but this cannot be confirmed until the packet is decrypted. Fragments are retained until all fragments have been received. Upon receiving the packet, the receiver determines whether an SA exists to process the packet. If no SA exists, then the packet is dropped. Once the SA is identified, the packet processing can begin.

The sequence number 406b is checked first to determine whether it is valid, i.e., not a duplicate or not within the sequence window. The packet is then authenticated by passing the entire packet without the authentication data with the appropriate key to the authenticator algorithm designated by the SA. The resultant digest is then compared for a match to the authentication data in the packet.

The encrypted portion of the packet is then decrypted using a key and cipher algorithm from the SA. The decryption can be verified using data from the pad. The packet is then checked for validity, e.g., determining whether the SA dictates that only ESP packets in a particular mode (tunnel or transport) can be processed. The packet is then rebuilt and the outer IP header 402 and the ESP header 406 can be discarded for tunnel mode packets, leaving the decapsulated packet. The SA can then require packets be processed only for a particular host or protocol. Non-compliant packets are discarded.

The reconstructed and validated packet is then forwarded for further processing. For example, tunnel mode packets are reinserted into the IP processing stream and forwarded to their ultimate destination.

As is well known to one of ordinary skill in the art, a security association SA provides a mechanism to associate security services and a key with data to be protected and a remote peer with which IPSec data is to be exchanged for proper packet encapsulation and decapsulation. SAs are unidirectional in that each SA, which typically exists in pairs, is associated with inbound or outbound traffic. SAs are identified by a Security Parameter Index (SPI), which is located in IPSec protocol headers, the IPSec protocol value, and the destination address to which the SA applies. SAs reside in the Security Association Database (SADB).

SAs are created in a two-step process. First, the SA parameters are negotiated and, second, the SADB is updated with the SA. For IPSec, IKE can be utilized to create the SAs. For example, the IPSec kernel can invoke IKE when the security policy requires a secure connection and an SA is not found. IKE negotiates the SA with the destination or intermediate router and creates the SA. The SA is then added to the SADB and the hosts can communicate.

SAs are used with IPSec to define the processing performed for associated packets. An outgoing packet generates a hit in the Security Policy Database (SPD), which then points to an SA. If there is no SA that instantiates the security policy from the SPD, one is created using Internet Key Exchange (IKE). IKE establishes shared security parameters and authenticated keys between IPSec peers. As is known to one of ordinary skill in the art, the IKE protocol operates within a framework identified by the Internet Security Association and Key Management Protocol (ISAKMP). ISAKMP defines packet formats, retransmission timers, and message construction requirements.

To enable identification of the SA for each packet at its destination, the SPI is sent with each packet in the ESP header. The destination uses the SPI for a lookup in the SADB to retrieve the SA.

IPSec policy is maintained in the SPD. Each SPD entry defines the traffic to be protected, how it is protected, and with what the protection is shared. For each packet entering or leaving the IP stack, the SPD is examined for possible security application. Upon each traffic match, the SPD directs one of three actions: discard, bypass (no security) and protect. For protect, security is applied on outbound packets and inbound packets are required to have security services applied. SPD entries that indicate protect point to an SA or SA bundle associated with the packet.

IP traffic is mapped to IPSec policy by selectors (coarse or fine) which identify some component of traffic. IPSec selectors include destination IP address, source IP address, name, upper-layer protocol source and destination ports, and a data sensitivity level. The selector values can be specific entries, ranges or opaque. The security policy determines the security services associated with each packet. The SPD stores the security service information, which can be indexed by selector information.

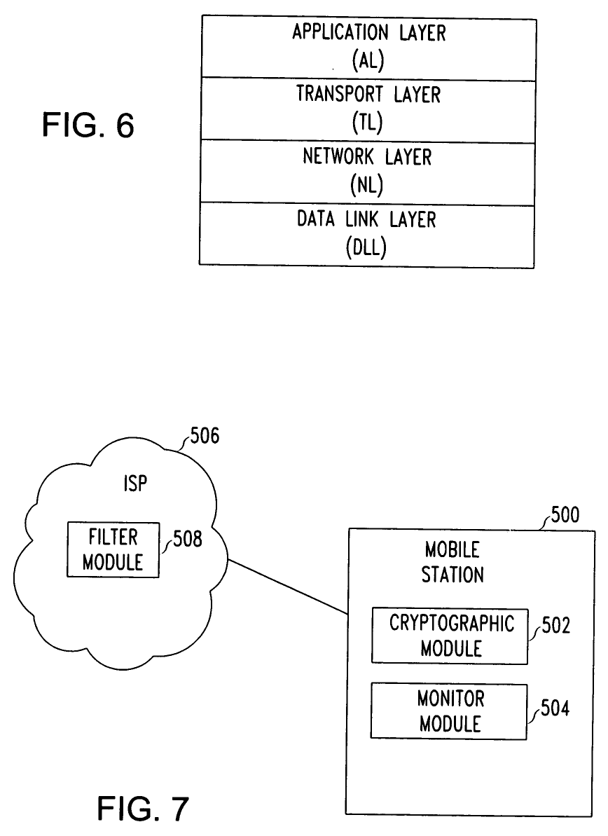

For outbound packet processing, the transport layer packets flow into the IP layer. FIG. 6 shows the well known TCP/IP protocol stack including the application layer AL, the transport layer TL, the network layer NL, and the data link layer DLL. The IP (network) layer interacts with the SPD to determine the security services for each packet. Based upon the SPD information, the packet is dropped, dispatched without security, or secured as directed by the SA.

For inbound packet processing, the receiver determines whether the packet contains any IPSec headers. If there is no IPSec header, the security layer checks the policy to determine how to process the packet. Based upon the appropriate SPD entry for the packet, the SPD output is discard, bypass or apply. If the policy commands apply and no SA is present, then the packet is discarded. Packets are then passed up to the next layer for processing.

If the packet does contain an IPSec header, the packet is processed by the IPSec layer, which extracts the SPI, the source address, and the destination address from the IP datagram. Then the IPSec layer indexes the SADB using the tuple <SPI, dest, protocol(AH or ESP)>. Based upon the protocol, the packet is sent to either the AH layer or the ESP layer. After the protocol payload is processed, the policy is consulted using the selectors to validate the payload.

For tunnel packet validation, it is understood that the source and destination selector fields from the inner header and not the outer header are used for indexing into the SPD. Once the IPSec layer validates the policy, the IPSec header is stripped off and the packet is sent to the next layer, which is either the transport layer or the network layer.

In one aspect of the invention, referring now to FIG. 7, an exemplary mobile host 500 includes a cryptographic module 502 for encrypting/decrypting packets, as described above in conjunction with IPSec processing for example, and a monitor module 504 for detecting the presence of inbound and/or outbound non-VPN packets. As used herein, non-VPN packets refers to packets that are not IPsec-protected or part of an ISAKMP keying exchange. Such packets can be readily identified by examining the “Protocol” field in the IP header [RFC 791] and possibly the port numbers in the UDP header [RFC 768]. The mobile host 500 is served by an ISP network 506 that includes a filter module 508 for filtering non-VPN packets over an IPSec VPN tunnel between the mobile host 500 and a remote network (not shown), such as a corporate intranet.

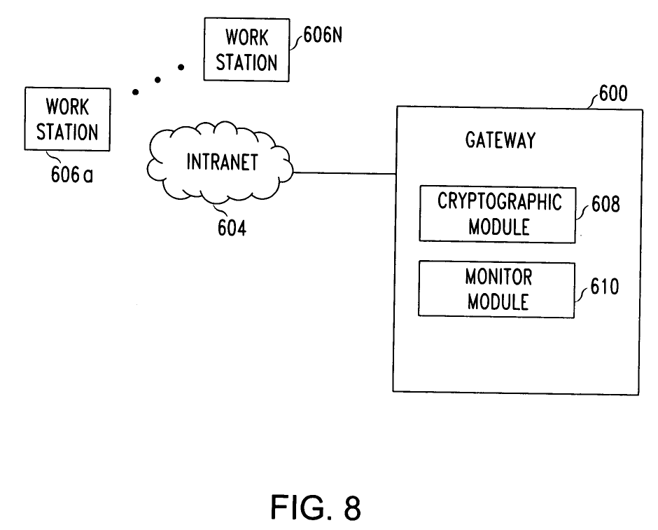

Similarly, as shown in FIG. 8, a gateway 600 for a corporate intranet 604 serving various work stations 606a-N can also include a cryptographic module 608 and a monitor module 610 for providing a secure tunnel with the mobile host of FIG. 7 via the Internet.

It is understood that the ISP network 506 can be provided from a wide variety of wired and wireless technologies including cable modems, Digital Subscriber Lines (DSLs), IEEE 802.11 wireless device, dial-up connections and the like. It is further understood that the tunnel endpoint hosts can be selected from a variety of devices and systems. Exemplary tunnel hosts include various computers and workstations running any number of operating systems such as Windows, Linux, and Solaris. In one particular embodiment, the mobile host 500 is provided as a computer running the Linux operating system served by a DSL Internet Service Provider (ISP) type network. Mobile devices can be provided as any number of device types including mobile phones, personal digital assistants, and portable computers.

Referring now to FIG. 8 in combination with FIG. 7, the ISP network 506 filter module 508 filters non-VPN packets passing through a tunnel established between the mobile host 500 and the corporate intranet/gateway 600. The monitor modules 504, 610 at the tunnel endpoints examine each packet transmitted/received over the tunnel for the presence of non-VPN packets. That is, the monitor modules 504, 610 can identify a filter that is not properly filtering out non-VPN packets. Upon detection of the non-VPN packets, the monitor modules 504, 610 should alert the mobile host 500 and/or the gateway 600 so that appropriate action can be taken, such as terminating the tunnel.

An ISP network should be provisioned, either statically or dynamically, to recognize certain endpoint addresses as belonging to monitored tunnels. In one embodiment, an outbound tunnel packet is recognized if (a) it is destined for one of the designated addresses; and (b) it has an IP protocol type that is equal to “17” (UDP) and the UDP port number is 500, or (b) it has an IP protocol type of 50 (ESP), or (b″) it has an IP protocol type of 51 (AH). A packet destined for such an address that is not matched by these rules is flagged as a non-tunnel packet.

Similarly, packets originating from such hosts, which can be identified either by IP source address or by topology, i.e., they came in on a particular wire, must match the same (b) criteria to be tunnel packets.

In one embodiment, filtering and/or monitoring of a VPN tunnel by an ISP is arranged in advance with the operator of the corporate intranet or other tunnel endpoint and/or with the mobile host operator. For example, an employer can arrange with an ISP to set up a filter on an employee's access link to block packets, inbound and outbound, that are associated with the VPN in question. For example, the filter blocks packets that are not IPSec packets transmitted/received from/to the designated machine. With this arrangement, the employee, the employer, the ISP, and/or an outside party can monitor the tunnel to ensure that it is operating properly. For example, the employee's monitor module, upon detecting a non-conforming packet, can send an alarm to the employer's monitor module.

In addition, such as in the event that the employer's monitor module and/or some third party try to send non-conforming packets, e.g., unencrypted packets, to the telecommuter's machine that get though any filters, the employee's monitor module will detect the non-conforming packets. Such packets can be sent to test the filter/monitor operation. In one embodiment, the monitor module then sounds an alarm and/or sends an alarm message. In an exemplary embodiment, the alarm packets are digitally signed by monitor module to prevent false alarms caused by deliberately spoofed alarm packets.

The crypto modules and the monitors can be done in hardware or software, in the same box as another computer or as a special-purpose module.

Exemplary tunneling protocols for filtering VPNs in accordance with the present invention include GRE (Generalized Router Encapsulation); PPTP (Microsoft's tunnel protocol), and l2tp (layer 2 tunneling protocol).

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method of filtering a secure channel, comprising:
establishing a secure tunnel between first and second devices over at least a first network; and
filtering packets at the first network to block packets that do not meet specified requirements for packets over the secure tunnel.

2. The method according to claim 1, further including monitoring the tunnel packets to detect packets that should have been blocked by the packet filtering.

3. The method according to claim 1, further including monitoring the tunnel packets at the first device.

4. The method according to claim 3, wherein the first device corresponds to a mobile device.

5. The method according to claim 3, further including selecting the mobile device from the group consisting of mobile phones, personal digital assistants, and portable computers.

6. The method according to claim 1, further including providing the first network as an Internet Service Provider network.

7. The method according to claim 1, further including monitoring the tunnel packets at the second device.

8. The method according to claim 1, wherein the specified requirements include at least one of endpoint addresses for the tunnel and IPSEC packet format.

9. A method of monitoring a secure link, comprising:
recognizing a Virtual Private Network (VPN) tunnel between a first device and a second device; and
filtering traffic within an Internet Service Provider (ISP) network through which the tunnel passes to block packets that are not encrypted packets addressed to or from one of the first and second devices.

10. The method according to claim 9, further including passing an alert message from a monitor module at the first device indicating that the monitor module has detected a packet that should have been filtered.

11. The method according to claim 9, further including monitoring data received over the tunnel by the first device to detect packets that should have been blocked by the filtering in the ISP network.

12. The method according to claim 11, further including monitoring data received over the tunnel by the second device to detect packets that should have been blocked by the filtering in the ISP network.

13. The method according to claim 9, further including directing packets addressed to the first device to test the packet monitoring at the first device.

14. A network, comprising:
a plurality of switching devices for providing connection paths through the network including secure tunnels; and
a filter module for filtering packets in a first secure tunnel through the network between first and second devices external to the network.

15. The network according to claim 14, wherein the network includes an Internet Service Provider (ISP) network.

16. The network according to claim 15, wherein the ISP includes a monitor module for detecting packets not meeting predetermined requirements.

17. The network according to claim 16, wherein the network further includes a test module for testing operation of the filter module and/or monitor module.

18. The network according to claim 16, wherein the predetermined requirements include one or more of packets being VPN packets, packets being addressed to one of the first and second devices, and packets being transmitted from one of the first and second devices.

19. The network according to claim 14, wherein the network identifies the first secure tunnel as an IPSEC VPN tunnel.

20. The network according to claim 14, wherein the second device includes a gateway coupled to a corporate intranet.

21. The network according to claim 14, wherein the first device includes a mobile device.

22. The network according to claim 16, wherein the mobile device is selected from the group consisting of mobile telephones, personal digital assistants, and portable computers.

23. The network according to claim 14, wherein the secure tunnel is an IPSec VPN tunnel.
